SEQUENCE LISTING (6 sequences)

SEQ ID NO: 1 - DNA, 48 bp, Artificial Sequence
  Synthetic (nucleotide for manufacturing a nucleic acid structure)
ttttttccagcaactacggacacgtactgcatcgrarcggacgctacc

SEQ ID NO: 2 - DNA, 32 bp, Artificial Sequence
  Synthetic (nucleotide for manufacturing a nucleic acid structure)
tttttgttgtgcctgagcaccagtcgtttttt

SEQ ID NO: 3 - DNA, 26 bp, Artificial Sequence
  Synthetic (nucleotide for manufacturing a nucleic acid structure)
ttttttctagtcctgtatgtcatgcc

SEQ ID NO: 4 - DNA, 26 bp, Artificial Sequence
  Synthetic (nucleotide for manufacturing a nucleic acid structure)
cgactggtcgtcaccgtagttgctgg

SEQ ID NO: 5 - DNA, 47 bp, Artificial Sequence
  Synthetic (nucleotide for manufacturing a nucleic acid structure)
tttttatgcagtacgtgtggcacaacggcatgacatacaccgatacg

SEQ ID NO: 6 - DNA, 21 bp, Artificial Sequence
  Synthetic (nucleotide for manufacturing a nucleic acid structure)
ttttttggtagcgtggactag

(19) United States
(12) Patent Application Publication
(10) Pub. No.: US 2014/0356857 A1
(43) Pub. Date: Dec. 4, 2014

(54) INTERPARTICLE SPACING MATERIAL INCLUDING NUCLEIC ACID STRUCTURES AND USE THEREOF

(71) Applicants: Samsung Electronics Co., Ltd., Suwon-si (KR); Sungkyunkwan University Foundation for Corporate Collaboration, Suwon-si (KR)

(72) Inventors: Myoung-soon KIM, Anyang-si (KR); Sung-ha Park, Suwon-si (KR); Jun-wye Lee, Suwon-si (KR); Jong-myeon Park, Incheon (KR); Nam Huh, Seoul (KR)

(73) Assignees: Samsung Electronics Co., Ltd., Suwon-si (KR); Sungkyunkwan University Foundation for Corporate Collaboration, Suwon-si (KR)

(21) Appl. No.: 14/285,870

(22) Filed: May 23, 2014

(30) Foreign Application Priority Data
May 31, 2013 (KR) 10-2013-0063114

(51) Int. Cl. G01N 21/65

(52) U.S. Cl. CPC G01N 21/658
USPC 435/5; 536/23.1; 435/6.1; 436/501

(57) ABSTRACT

Provided is an interparticle spacing material comprising a nucleic acid structure which comprises at least one nucleic acid lattice comprising a double helix domain; and at least one metal particle which is in contact with a plane of the nucleic acid lattice, in a direction extending obliquely or perpendicularly away from the plane; wherein the double helix domain comprises a hybridization area in which a single strand is hybridized with another single strand.

### CROSS-REFERENCE TO RELATED APPLICATIONS

This application claims the benefit of Korean Patent Application No. 10-2013-0063114, filed on May 31, 2013, in the Korean Intellectual Property Office, the entire disclosure of which is hereby incorporated by reference.

### INCORPORATION-BY-REFERENCE OF MATERIAL SUBMITTED ELECTRONICALLY

Incorporated by reference in its entirety herein is a computer-readable nucleotide/amino acid sequence listing submitted concurrently herewith and identified as follows: One 1,795 Bytes ASCII (Text) file named “715872_ST25.TXT,” created on May 19, 2014.

### BACKGROUND OF THE INVENTION

1. Field

Disclosed is an interparticle spacing material including nucleic acid structures and uses thereof.

2. Description of the Related Art

A method for the accurate detection of a single molecule with high sensitivity can be widely used in various fields including medicinal diagnostics, pathology, toxicology, and chemical analyses. To this end, nanoparticles or chemical substances labeled with a specific compound, for example radioisotopes and organic fluorescent molecules, have been used in the fields of biology and chemistry to study the metabolism, distribution, and coupling of organic molecules.

Furthermore, there are methods using plasmon resonance, for example, a labeling material using surface plasmon resonance such as Raman spectroscopy. Raman scattering refers to a phenomenon in which the energy of incident photons are irradiated onto a specific molecule in the form of an inelastic scattering that generates light with a frequency that is slightly different than that of the incident photons, due to the intrinsic resonance of the molecule. With many feasible applications, Raman spectroscopy has not been yet commercialized due to its rather low signal intensity and poor reproducibility.

Surface Enhanced Raman Spectroscopy, also known as Surface Enhanced Raman Scattering (SERS), is one method that may address some of the problems associated with Raman spectroscopy. When oxidation-reduction reactions are repeatedly performed in an Ag electrode, the signal intensity of the Ag electrode is shown to increase about 10⁶ fold after a pyridine molecule is adsorbed in an aqueous solution. However, the SERS phenomenon suffers in terms of synthesis and control of nano materials which are accurately defined in their structures. Accordingly, there remains a need for improvements in plasmon resonance technology like SERS.

### BRIEF SUMMARY OF THE INVENTION

According to one aspect of the present disclosure an interparticle spacing material including a nucleic acid structure, and at least one metal particle is provided.

According to another aspect of the present disclosure, a method for controlling interparticle spacing is provided, which method includes connecting at least one metal particle to each lateral side of the nucleic acid structures.

In a further aspect of the present disclosure, a method for manufacturing an interparticle spacing material is provided.

According to a still further aspect of the present disclosure, a method for detecting a target material using an interparticle spacing material is provided.

### BRIEF DESCRIPTION OF THE DRAWINGS

These and/or other aspects will become apparent and more readily appreciated from the following description of the embodiments, taken in conjunction with the accompanying drawings of which:

FIG. 1 shows a schematic diagram illustrating a method for manufacturing an interparticle spacing material including a DNA structure, a metal particle, and a Raman-active molecule according to an exemplary embodiment of the present invention;

FIG. 2 shows a schematic diagram illustrating (c) and (d) of FIG. 1;

FIG. 3 shows a diagram illustrating a nucleic acid sequence designed for manufacturing a DNA structure according to an exemplary embodiment of the present invention;

FIG. 4 shows an exemplary diagram illustrating a nucleic acid structure according to an exemplary embodiment of the present invention;

FIG. 5 shows an atomic force microscopy (AFM) image of a DNA nanostructure obtained according to an exemplary embodiment of the present invention;

FIG. 6 shows a picture of a nucleic acid structure confirmed via gel electrophoresis synthesized according to an exemplary embodiment of the present invention;

FIGS. 7A and 7B show transmission electron microscopy (TEM) images of an Au dimer and a DNA nanostructure synthesized according to an exemplary embodiment of the present invention;

FIGS. 8A and 8B show transmission electron microscopy (TEM) images of Ag_{E}/Au-DNA according to an exemplary embodiment of the present invention;

FIG. 9 shows a graph of a UV-Vis spectra of Au-DNA and Ag_{E}/Au-DNA according to an exemplary embodiment of the present invention;

FIGS. 10A and 10B show graphs of an EDS spectra of Au-DNA and Ag_{E}/Au-DNA according to an exemplary embodiment of the present invention; and

FIG. 11 shows a result of an SERS spectrum measured using Au-DNA nanostructure and Ag_{E}/Au-DNA nanostructure according to an exemplary embodiment of the present invention.

### DETAILED DESCRIPTION OF THE INVENTION

Additional aspects will be set forth in part in the following description and, in part, will be apparent from the description, or may be learned by practice of the presented embodiments.

In one aspect, an interparticle spacing material includes a nucleic acid structure which includes at least one nucleic acid lattice with a double helix domain; and at least one metal particle which is attached or connected to the nucleic acid lattice. The metal particle may be attached in a direction extending oblique or perpendicular to the plane of the nucleic acid lattice. The plane of the nucleic acid lattice may be formed by the adjacent double helices. Therefore the plane may be defined by the adjacent multiple double helices, and have a lengthwise dimension equal to the length of the multiple double helices and a widthwise dimension equal to the combined width of the adjacent double helices. The thickness of the lattice in a direction perpendicular to the plane may be defined by the diameter of a single double helix if the lattice contains a single layer of adjacent double helices, or the thickness of the lattice may be defined by the combined diameter of multiple double helices if the lattice contains multiple layers of nucleic acids. The plane of the nucleic acid lattice may be parallel with the axis of a double helix of the double helix domain.

The term “an interparticle spacing material” used herein refers to a material which may control the distance between particles, which material may include the particles themselves. The distance between the at least one metal particle connected to each lateral side of a nucleic acid structure may be controlled by the thickness of the nucleic acid structure.

The double helix domain may be multiple double helices aligned and interconnected, and the multiple double helices may align into a flat or planar structure. The double helix domain may include a hybridization area in which a single strand is hybridized with another single strand. The nucleic acid structure may be a multi-crossover nucleic acid structure. The multi-crossover nucleic acid structure refers to a nucleic acid structure including at least two crossover sites. The crossover sites may be branched junctions comprising at least two nucleic acid double helix domains. The branched junction may be a holliday junction. The multi-crossover nucleic acid structure may be a double-crossover nucleic acid, a triple-crossover nucleic acid, or combinations thereof. When there are more than two crossover sites, one of ordinary skill in the art will understand that a half turn between each pair of neighboring crossover sites is designed so that the multi-crossover nucleic acid structure may maintain the same plane. Furthermore, the at least two nucleic acid lattices may be located on the same plane. The width of the plane of the lattice may be defined by the number of adjacent helices aligned in the lattice to make the planar structure. The at least two nucleic acid lattices may be a tiling array disposed on the same plane. Therefore, one skilled in the art can understand that the nucleic acid structure is designed to maintain the same plane.

A nucleic acid lattice comprising a double helix domain may be an anti-parallel double-crossover or parallel double-crossover nucleic acid. The anti-parallel double-crossover nucleic acid may be a DAE which has an even number of half-turns of a double helix between the crossover sites, or a DAO which has an odd number of half turns of a double helix between the crossover sites. Furthermore, the parallel double-crossover nucleic acid may be a DPE which has an even number of half-turns of a double helix between the crossover sites, a DPON which has an odd number of half turns of a double helix between the crossover sites, with one and a half turns including one major groove spacing and two minor groove spacing, or a DPOW which has an odd number of half turns of a double helix between the crossover sites, with one and a half turns including one minor groove spacing and two major groove spacing (see US 20070129898 A). The nucleic acid lattice may be a repeat unit of an anti-parallel double-crossover or parallel double-crossover nucleic acid. The nucleic acid lattice may include a plurality of repeat units, i.e., a plurality of nucleic acid lattices.

In addition, a double helix domain of the nucleic acid structure may include a hybridization area in which a single strand is hybridized with a single strand. A double helix domain may be connected to another double helix domain at least one via crossover strands.

The nucleic acid structure may be manufactured from at least one oligonucleotide (see Chengde Mao et al, PLoS Biology, December 2004, Volume 2, Issue 12, e431). The nucleic acid that forms the nucleic acid structure may include a hybridization area in which a single strand is hybridized with a single strand. The nucleic acid which includes the hybridization area may be hybridized with each other, thereby forming a double stranded nucleic acid. The double stranded nucleic acid may be formed by hybridization of an oligonucleotide to itself or with another oligonucleotide. An oligonucleotide may include at least one hybridization area. An oligonucleotide may include a plurality of hybridization areas. An oligonucleotide may be hybridized with itself and/or hybridization areas of other oligonucleotides. The nucleic acid structure may be self-assembled. The nucleic acid structure may have a shape predetermined by base pairing. The base pairing may be formed by a programmed base pair (see WO 2012151537 A). The term “self-assembly” used herein refers to a phenomenon where a nanostructure is formed automatically by a covalent bond between atoms or an interaction between molecules, thereby establishing a specific structure. An oligonucleotide may include a complementary nucleotide sequence which can be hybridized with other oligonucleotides. Nucleic acids can be self-assembled via hybridization between complementary sequences.

The nucleic acid structure may include a surface localized fluorescent entity or a Raman-active molecule entity such as a Raman-active molecule. Plasmon-resonance induced fluorescence emission induced by plasmon-resonance from at least one entity above or Raman spectroscopy emission is then measured.

Raman scattering refers to a phenomenon where a fraction of light (photons), while passing through a medium, is broken away from the direction of its progress and proceeds in a different direction. The term “surface enhanced Raman spectroscopy, surface enhanced Raman scattering (SERS)” used herein refers to a phenomenon in which the intensity of the Raman scattering of a molecule increases when the molecule is present in the vicinity of a metal nanostructure. The nucleic acid structure may include nucleic acids selected from the group consisting of DNA, RNA, PNA (peptide nucleic acids), LNA (locked nucleic acids), nucleic acid-like structures, combinations thereof, and their analogues. The nucleic acid may include analogues which are similar to natural nucleotides or those having improved binding properties. The nucleic acid structure may include nucleic acid-like nanostructures having a synthetic backbone. The synthetic backbone analogues may include phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholinocarbamate, peptide nucleic acid (PNA), modified phosphodiester, or modified methylphosphonate bonding. The DNA used to manufacture the nucleic acid structures may be naturally occurring DNA, modified DNA, or synthetic DNA.

The nucleic acid structures may be detectably labeled. The labeling may include a fluorescent molecule, a radioisotope, an enzyme, an antibody, or a linker compound. The term “linker compound” used herein refers to a compound connected to the sequence of each oligonucleotide so as to attach each oligonucleotide to the metal particle. The linker compound may be connected to a 5′-terminus and/or 3′-terminus of each oligonucleotide. The method of connecting the metal particle to the linker compound has been disclosed in the related art. One terminus of the linker compound may include a functional group to be attached to the surface of the metal particle. The functional group may include, for example, a sulfur-containing group including a thiol group or a sulfhydryl group. The functional group, being a derivative of alcohol and/or phenol, may be a compound having a formula of RSH where oxygen is replaced with sulfur. The functional group may be a thiol ester or a dithiol ester having a formula of RSR′ or RSSR, respectively. Further, the functional group may be an amino group (—NH₂) or a carboxyl group. The metal particle may be attached to the nucleic acid structures via the linker compound. The metal particle may be attached to a vertex of the nucleic acid structures via a linker compound connected to a 5′-terminus and/or 3′-terminus of each oligonucleotide.

In the nucleic acid structures, the metal particle may be used for measuring plasmon such as a Raman signal. The metal particle may be an optically active molecule. The metal particle may be selected from the group consisting of Au, Ag, Cu, Na, Al, Cr, Pt, Ru, Pd, Fe, Co, Ni and combinations thereof. The metal particle may be a metal nanoparticle. Furthermore, the metal particle may be a metal ion or a chelate of a metal ion. The metal particle may be manufactured by a conventional method in the related art, and a suitable metal particle may be one with a conventional particle size distribution and image distribution. For example, a metal particle may be spherical in shape. In addition, the size of the metal particle may be in the range of about 2 nm to about 100 nm, about 5 nm to about 50 nm, about 5 nm to about 40 nm, about 10 nm to about 40 nm, about 50 nm to about 90 nm, about 60 nm to about 80 nm, or about 10 nm to about 30 nm. The size of a metal particle may be appropriately defined according to the shape of its nanoparticle. For example, when the metal particle is spherical, its diameter defines its size, and when the metal particle is non-spherical, it may be defined by the dimension of its longest axis.

The term, “signal material” used herein is a comprehensive term that may include a Raman-active material, a fluorescent organic material, a non-fluorescent organic material, and an inorganic nanoparticle, and may include an index material which enables color development without any limitation. The term “Raman-active molecule” used herein refers to a molecule which facilitates the processes of detecting and measuring analytes using a Raman detection apparatus when nanoparticles according to the present disclosure are attached to at least one analyte. The Raman-active molecule may include a surface enhanced Raman-active molecule, a surface enhanced resonance Raman-active molecule, a hyper Raman-active molecule, and a coherent anti-stokes Raman-active molecule. The Raman-active material may generate a sharp spectrum peak. The Raman-active material may include a Raman-active tag. The Raman scattering active molecule may be selected from the group consisting of cyanine, fluorescein, rhodamine, 7-nitrobenz-2-oxa-1,3-diazole (NBD), phthalic acid, terephthalic acid, isophthalic acid, cresyl fast violet, cresyl blue violet, brilliant cresyl blue, p-aminobenzoic acid, erythrosine, biotin, digoxigenin, phthalocyanine, azomethine, xanthine, N,N-diethyl-4-(5′-azobenzotriazolyl)-phenylamine, aminoacridine, and combinations thereof. Examples of cyanines may include Cy3, Cy3.5, or Cy5. Examples of fluoresceins may include carboxyfluorescein (FAM), 6-carboxy-2′,4,4′,5′,7,7′-hexachlorofluorescein (HEX), 6-carboxy-2′,4,7,7′-tetrachlorofluorescein (TET), 6-carboxy-4′,5′-dichloro-2′,7′-dimethoxyfluorescein (Joe), 5-carboxy-2′,4′,5′,7′-tetrachlorofluorescein, 5-carboxyfluorescein, and succinylfluorescein. Examples of rhodamines may include tetramethylrhodamine (Tamra), 5-carboxyrhodamine, 6-carboxyrhodamine, 6G (Rhodamine 6G: R6G), tetramethyl rhodamine isothiol (TRIT), sulforhodamine 101 acid chloride (Texas Red dye), carboxy-X-rhodamine (Rox), and rhodamine B.

The metal particle may be chemically reduced or may undergo laser ablation. The metal particle may be a core-shell particle. The core-shell metal particle may include a core and a shell, and the core may be formed of Au and the shell may be formed of Ag. In the nucleic acid structures, a target material may be bound to the surface of the metal particle. The surface of the metal particle may include a material such as an organic or inorganic molecule or material that may bind to the target material. The organic material may be a protein, a nucleic acid, a sugar or combinations thereof. The organic material may be a pathogen. The material that binds to the target material may specifically bind to the target material. The specific binding may be, for example, in a ligand-receptor relationship in a broad sense with regard to the target material. An antibody to an antigen, a receptor to a ligand, an enzyme and a substrate, or an inhibitory factor may also be included. The material that binds to the target material may be any material that binds to a nucleic acid. The material that binds to a nucleic acid may be a specific binding material.

In another aspect, a method of controlling interparticle spacing by using an interparticle spacing material, including: connecting at least one metal particle to each lateral side of a nucleic acid structure in a direction extending obliquely or perpendicular to the plane of the nucleic acid lattice is provided. The nucleic acid structure may include a double helix domain comprising a hybridization area in which a single strand is hybridized with another single strand.

In another aspect, the nucleic acid structures may include a nucleic acid lattice comprising a double helix domain which includes a hybridization area in which a single strand is hybridized with a single strand. The nucleic acid structures are multi-crossover nucleic acid structures as described above in which the interparticle spacing (e.g., the gap between metal particles) may be controlled by the thickness of the nucleic acid structures between metal particles. The details of the nucleic acid structures and metal particles are the same as described above.

In still another aspect, a method of manufacturing an interparticle spacing material is provided, including: providing an oligonucleotide comprising at least one pair of complementary nucleotide sequences; forming a nucleic acid structure by hybridizing the oligonucleotide; and connecting at least one metal particle with each lateral side of the nucleic acid structure in a direction perpendicular to the plane of the nucleic acid structure or an axis of the nucleic acid structure (e.g., an axis of a double helix of the double helix domain).

In yet another aspect, a linker compound may be bound to the provided oligonucleotides. Additionally, a Raman-active molecule may be attached to the oligonucleotides. The details of the Raman-active molecule are the same as described above. In forming the nucleic acid structures, the nucleic acid structures may be self-assembled, and the details of the nucleic acid structures are the same as described above.

In manufacturing the interparticle spacing material, the process may further include reducing the metal particle. The metal particle may be chemically reduced or undergo laser ablation. Ag may be reduced on the surface of the metal particle by chemically reducing the surface of the metal particle.

In another aspect, a method of detecting a target material by using an interparticle spacing material is provided, the method including: providing an oligonucleotide comprising at least one pair of complementary nucleotide sequences; forming a nucleic acid structure by hybridizing the oligonucleotide; contacting at least one metal particle to each lateral side of the nucleic acid structure in the direction extending obliquely or perpendicularly away from the plane of the nucleic acid lattice; exposing the interparticle spacing material to a sample including a target material; and detecting plasmon formed from the target material and the interparticle spacing material.

The method of manufacturing an interparticle spacing material may include providing one or more oligonucleotides comprising one or more pairs of complementary nucleotide sequences; hybridizing the complementary nucleotide sequences of the one or more oligonucleotides to form a nucleic acid structure; and contacting at least one metal particle to each lateral side of the nucleic acid structure in a direction extending obliquely or perpendicularly away from the plane of the nucleic acid lattice. The details of the nucleic acid structures and metal particles are the same as described above. In providing the oligonucleotides, a linker compound may be attached to the oligonucleotides. A Raman-active molecule may be attached to the oligonucleotides. The details of the Raman-active molecule are the same as described above. In forming the nucleic acid structures, the nucleic acid structures may be self-assembled. In manufacturing the nucleic acid structures, the process may further include reducing the metal particle. The metal particle may be chemically reduced or undergo laser ablation.

In exposing the interparticle spacing material to a specimen including a target material, the sample may be anything that includes a target material. The target material may be a biotic or an abiotic material. The biotic material may be one derived from a virus or a biological material. The biotic material may include cells or their components. The cells may be eukaryotic cells or prokaryotic cells, for example, gram positive or gram negative bacteria. The biotic cell components may be proteins, fats, nucleic acids, or combinations thereof. The sample may include a biological material, for example, blood, urine, mucous swab, saliva, body fluids, tissues, biopsy materials, and combinations thereof.

In detecting plasmon formed from the target material and the interparticle spacing material, the plasmon detection may include Raman spectroscopy. The Raman spectroscopy may include Surface Enhanced Raman Spectroscopy (SERS), Surface Enhanced Resonance Raman Spectroscopy (SERRS), Hyper Raman Scattering, or Coherent Anti-Stokes Raman Scattering (CARS) (see Appl Spectrosc. 2011 August; 65(8):825-37, Applied Spectroscopy, Volume 31, Number 4, July/August 1977).

According to an aspect of the present disclosure, an interparticle spacing material may be used for measuring reproducible plasmon.

According to another aspect of the present invention, the method of manufacturing an interparticle spacing material may be used to manufacture a material to be used in measuring plasmon.

According to a further aspect of the present invention, the method of controlling interparticle spacing may be used to measure reproducible plasmon.

According to a still further aspect of the present invention, the method of detecting a target material may be used to measure reproducible plasmon, and may be also used for analyzing various target materials.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items.

The present disclosure is further illustrated by the following examples. However, it shall be understood that these examples are only to be used to specifically set forth the present disclosure, and they are not to be used to limit the present disclosure in any form.

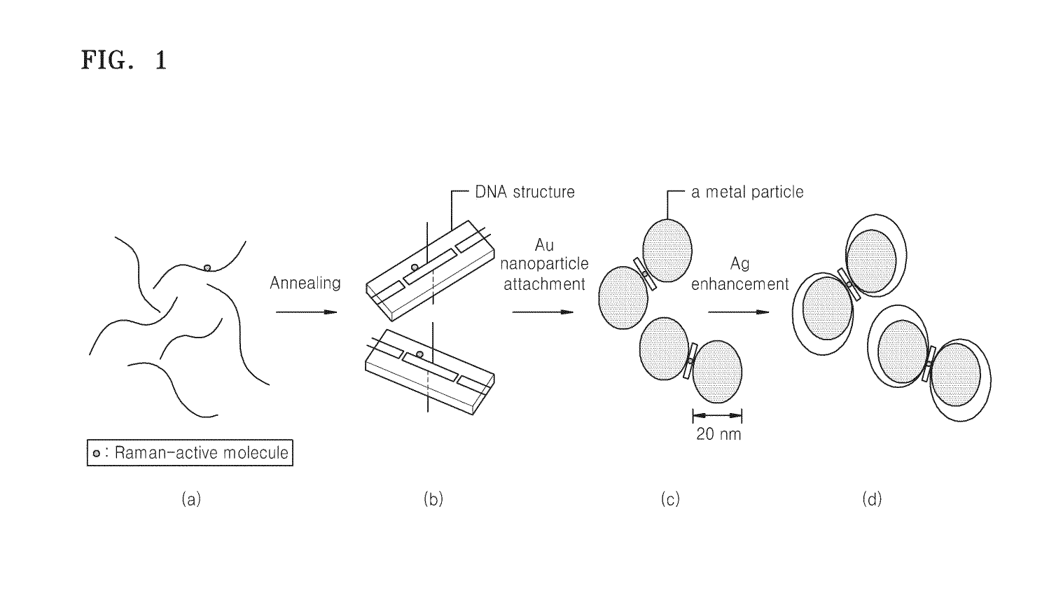

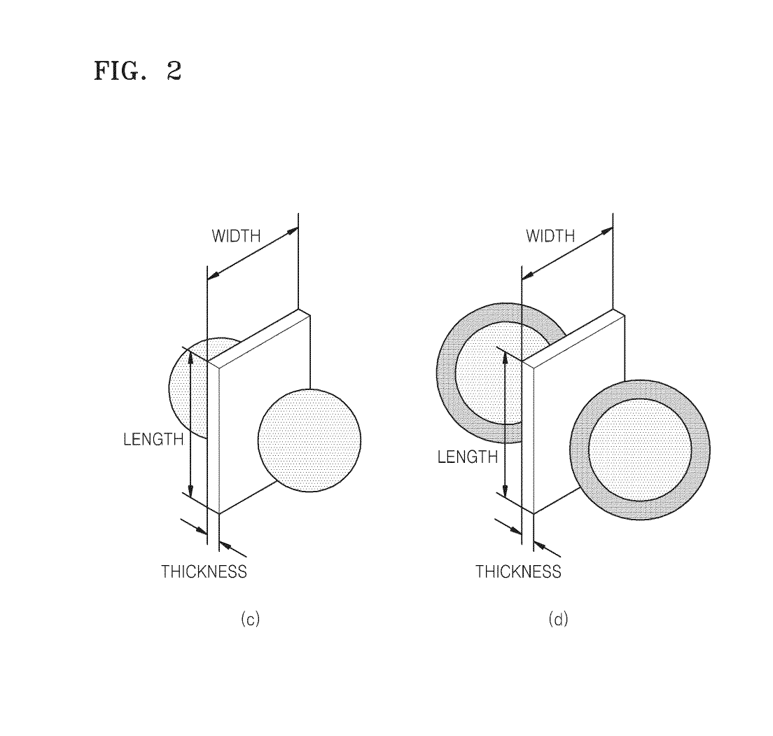

FIG. 1 shows a schematic diagram illustrating a method for manufacturing an interparticle spacing material including a DNA structure, a metal particle, and a Raman-active molecule according to an exemplary embodiment of the present invention. As shown in FIG. 1(a), 6 oligonucleotides including complementary nucleotide sequences may be provided. The oligonucleotides may include at least one Raman-active molecule such as Cy3. The Raman-active molecule may be included with each of the oligonucleotides. At least one Raman-active molecule may be introduced to any oligonucleotide. The Raman-active molecule may be introduced to oligonucleotides forming the DNA nanostructures, and may thus be introduced at any position along the DNA nanostructures. Furthermore, the number of Raman-active molecules to be introduced may vary.

The oligonucleotides may include a linker compound (not shown). Au particles may be attached to the DNA nanostructures via a linker compound having SH included in the oligonucleotides. The SH may be bound to a hydrocarbon. The SH may include —(SH)₂. The linker compound having the SH may be a dithiol group (see Nano Lett. 2007 July; 7(7): 2112-2115; US2011-0275061 A).

The oligonucleotides may include at least one hybridization area. The hybridization area may be an area where a single strand is hybridized with another single strand, or may include an area to be hybridized.

As shown in FIG. 1(b), a self-assembled two-dimensional polynucleic acid lattice or a two-dimensional polynucleic acid array may be formed by hybridization of the 6 oligonucleotides.

As shown in FIG. 1(c), interparticle spacing materials may be manufactured by respectively attaching two Au nanoparticles having an equal diameter to the lateral side of a nucleic acid lattice (one particle per side), in a direction extending obliquely or perpendicularly relative to a axis of a double helix of the double helix domain which establishes a formed two-dimensional nucleic acid lattice. When the two Au nanoparticles are attached perpendicularly to the nucleic acid structures of the two-dimensional nucleic acid lattice, the rigidity of the nucleic acid structures may be greater than that when the two Au nanoparticles are attached parallel to the nucleic acid structures of the two-dimensional nucleic acid lattice (i.e., in the same plane as that of the nucleic acid lattice, which is parallel with the axis of a double helix of the double helix domain). Accordingly, hot spots that generate a strong electromagnetic field to a local area may be controlled by using the more rigid nucleic acid structures, and as a result, a plasmon signal such as surface enhanced Raman scattering signal is reproducibly increased. The hot spots are closely packed nano-scaled features such as aggregates of nanoparticles. Furthermore, signal amplification by plasmon coupling can be obtained via a nanogap present between the metal particles formed by the nucleic acid structures formed between the metal particles. Still further, an uniform signal intensity can be provided in the nucleic acid structures disposed in the above gap by introducing a signal material, and controlling the position and amount of the signal material introduced therein.

As shown in FIG. 1(d), Ag enhancing may be achieved by selectively coating Ag on the surface of Au particles.

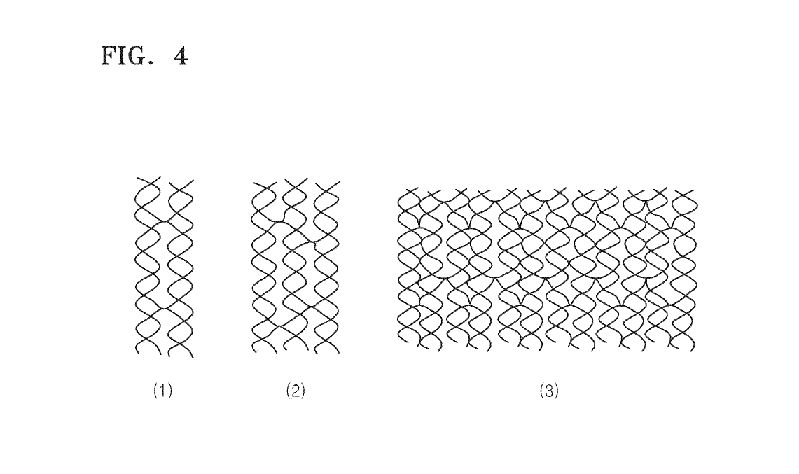

FIG. 4 shows an exemplary diagram illustrating a nucleic acid structure according to an exemplary embodiment of the present invention. FIG. 4(1) represents DX, FIG. 4(2) represents TX, FIG. 4(3) represents a multi-crossover nucleic acid. DX, TX, a multi-crossover nucleic acid, and combinations thereof may be used as nucleic acid structures.

### EXAMPLE 1

### Synthesis of DNA Nanostructures

DNA nanostructures with a double crossover were synthesized via self-assembly of 6 DNA sequences (see E. Winfree, F. Liu, L. A. Wenzler, N. C. Seeman, Nature 1998, 394, 539-544). DNA was adjusted to a final concentration of 100 nM using 1× TBE/NaCl buffer. Each of the DNA nanostructures used as a template for amplification was heated to 95° C. for annealing, and then slowly cooled down to room temperature. The resulting DNA nanostructures synthesized via self-assembly were tile arrays with double-crossover nucleic acid.

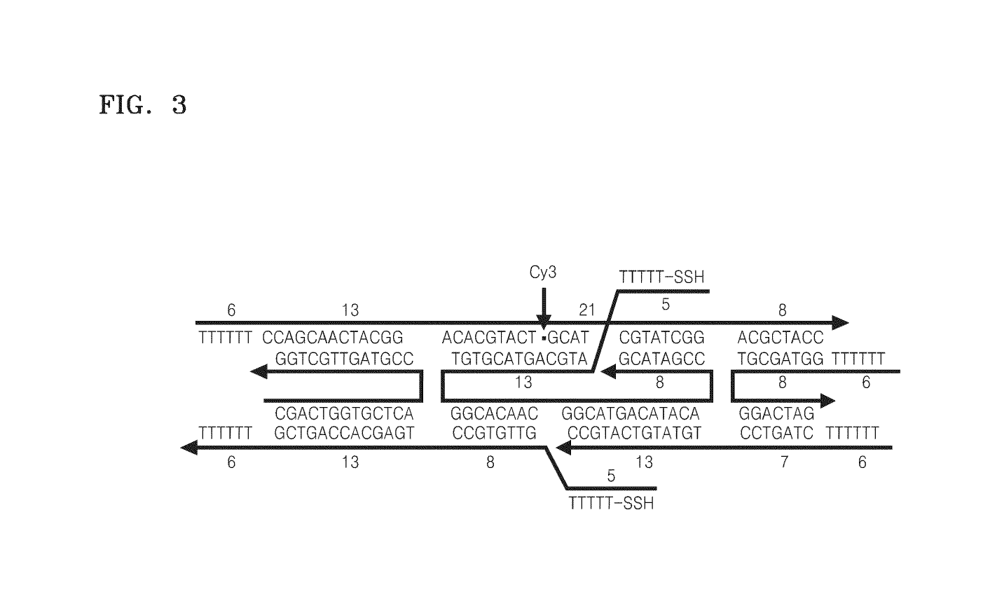

FIG. 3 shows a diagram illustrating a nucleic acid sequence designed for manufacturing a DNA structure according to an exemplary embodiment of the present invention. As shown in FIG. 3, DNA nanostructures consist of two neighboring double stranded DNA which are connected by two crossover junctions. In the two crossover junctions there are 21 nucleotides which make two complete turns of about 720°. The thus obtained DNA nanostructures can form a rigid two-dimensional image due to their strong tethering. The 6 nucleic acid sequences comprising a hybridization area with other nucleic acid sequences formed nucleic acid lattices as shown in FIG. 3.

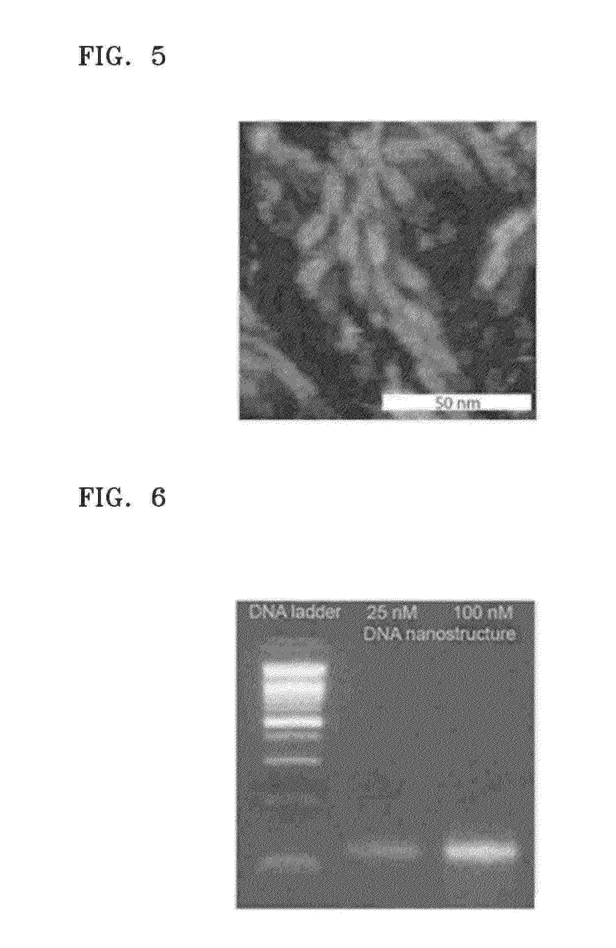

The presence of the DNA nanostructures was confirmed via atomic force microscopy (AFM). FIG. 5 shows an atomic force microscopy (AFM) image of a DNA nanostructure obtained according to an exemplary embodiment of the present invention. As shown in FIG. 5, the DNA nanostructures showed a rigid two-dimensional image. In addition, the synthesis of the DNA nanostructures was confirmed by a 3% agarose gel electrophoresis. FIG. 6 shows a picture of a nucleic acid structure confirmed via gel electrophoresis synthesized according to an exemplary embodiment of the present invention. As shown in FIG. 6, the second and third lanes from the left showed the same DNA band of 100 bps as that in the first lane.

### EXAMPLE 2

### Binding between DNA Nanostructures and Au Particles

A solution including the DNA nanostructures prepared in Example 1 and a TCEP solution were mixed in 1× TBE, 50 mM NaCl in a 1:5 volume ratio, and incubated for 1 hour to obtain sulfur-modified DNA strands.

In order to modify the surface of Au nanoparticles, the citrate-coated Au nanoparticles were treated with bis(p-sulfonatophenyl)phenylphosphine dihydrate dipotassium (BSPP) as follows. 40 mg of BSPP was added to Au nanoparticles coated with 100 mL of citrate and allowed to react overnight. Then, solid NaCl was slowly added to the reaction mixture until the mixture changed from blue to bright blue. The mixture was centrifuged at 3000 rpm for 30 min, and the resulting supernatant was discarded. The Au nanoparticle pellets were washed with 1 ml of methanol, then resuspended in 1 ml of 2.5 mM BSPP solution, and then the optical density of the Au nanoparticle pellets was measured at about 520 nm and quantitated.

TCEP-treated DNA nanostructures and BSPP-coated Au nanoparticles were mixed in 1:2 volume ratio and allowed to react at room temperature overnight. Then, the resultant was sprayed on a carbon film and dried overnight, and observed under TEM (TECNAL G2 F20 S-TWIN) and SEM (FE-SEM (S-4500)). As shown in the TEM picture of FIG. 6(b), an internal surface-to-surface distance of about 2 nm was observed, and no dimer was formed in the absence of DNA nanostructures.

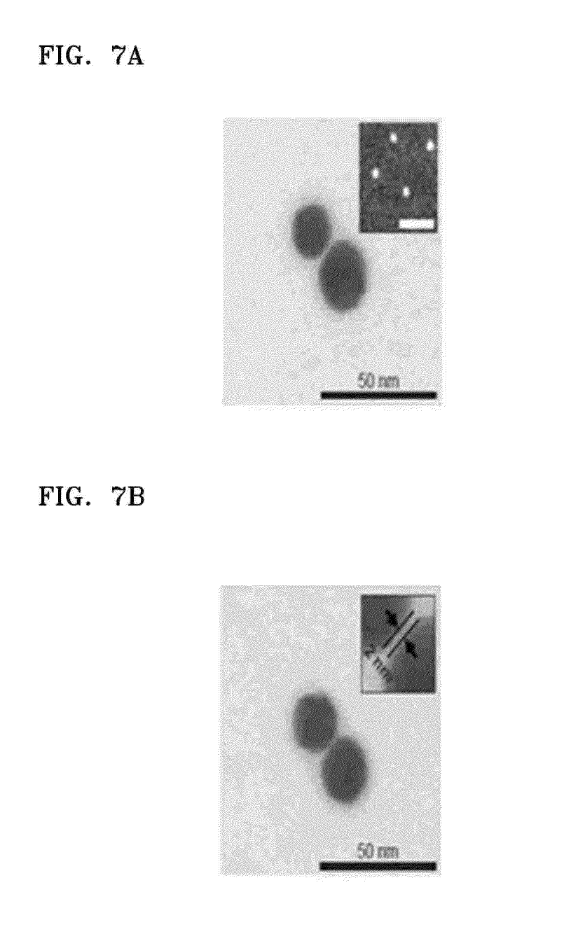

FIG. 7 shows a transmission electron microscopy (TEM) image of an Au dimer and a DNA nanostructure synthesized according to an exemplary embodiment of the present invention. As shown in FIG. 7A, a dimer of Au nanoparticles was observed in the presence of DNA nanostructures, whereas, as shown in the internal figure found in the top right corner of FIG. 7A, no dimer was formed in the absence of contact with the DNA nanostructures. In addition, as shown in the internal figure of FIG. 7B, a surface-to-surface distance of about 2 nm was observed among Au particles of a dimer.

### EXAMPLE 3

### Ag Coating on Au Particles

Ag_{E}/Au-DNA nanostructures, i.e., Au-DNA nanostructures where Ag is enhanced on the surface of Au particles, were obtained as follows. A solution containing 50 μl of dimeric Au-DNA nanostructures was allowed to react with 10 μl of 1 mM AgNO₃ overnight in the presence of 20 μl of 1% poly-vinyl-2-pyrrolidone as a stabilizer and 10 μl of 0.1 M L-sodium ascorbate as a reducing agent. The resultant was dissolved in 0.3 M PBS. The material obtained therefrom was observed under TEM, UV-VIS, and EDS, respectively.

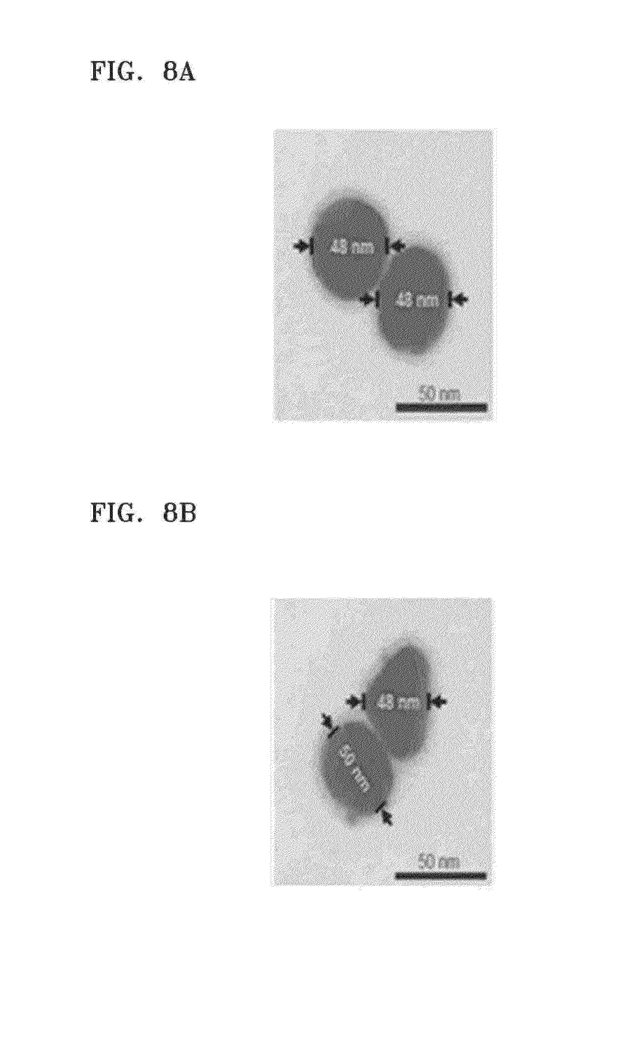

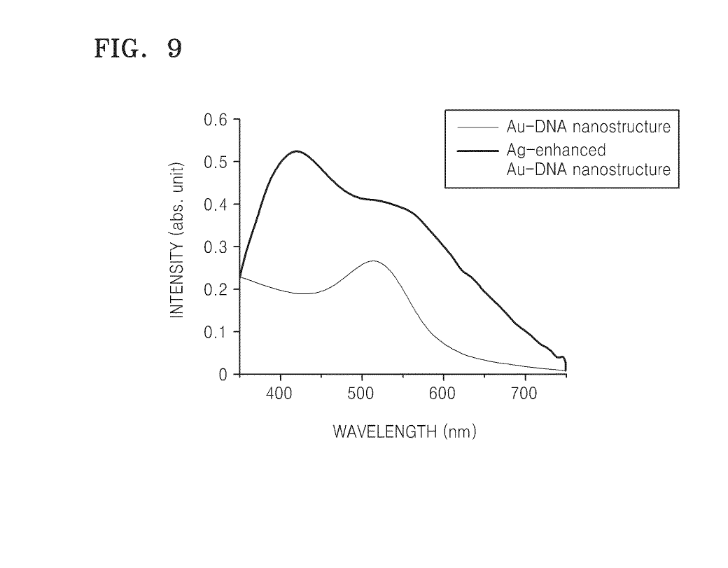

FIG. 8 shows a transmission electron microscopy (TEM) image of Ag_{E}/Au-DNA according to an exemplary embodiment of the present invention. As shown in FIGS. 8(a) and (b), the average size of the Ag-enhanced Au nanoparticles (Ag_{E}/Au) was about 49 nm. Furthermore, the distance between the surfaces of the two metal particles was not changed even after the Ag-enhancement due to the rigid two-dimensional DNA nanostructures disposed between the Au nanoparticles.

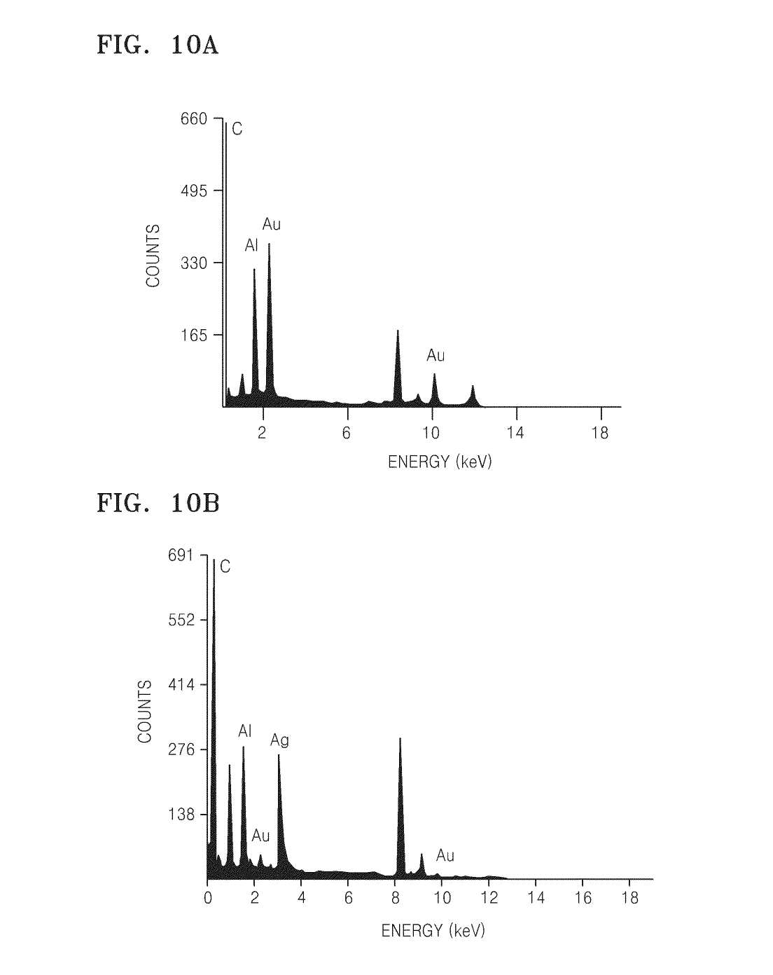

In order to confirm the Ag-enhancement on the surface of Au in the Au-DNA nanostructures, UV-Vis spectroscopy and energy dispersive spectrometer (EDS) were used. FIGS. 9 and 10 respectively show graphs of a UV-Vis spectra and an EDS spectra of Au-DNA and Ag_{E}/Au-DNA according to an exemplary embodiment of the present invention. As shown in FIG. 9, energy is absorbed at about 520 nm in the case of Au-DNA nanostructures where only Au nanoparticles are present, whereas a sharp specific Ag plasmon resonance peak is absorbed at about 420 nm in the case of Ag_{E}/Au-DNA nanostructures with Ag-enhancement, and energy is broadly absorbed at about 520 nm. As shown in FIG. 10, the EDS spectrum of the Ag_{E}/Au-DNA nanostructures showed a new characteristic peak at about 3.1 eV which is characteristic of Ag, and the size of the Au peak at about 2.1 and 9.8 eV was decreased after Ag-enhancement. From FIGS. 9 and 10 showing the changes before and after Ag-enhancement, it was confirmed that Ag_{E}/Au-DNA nanostructures were formed due to the Ag-enhancement in the Au-DNA nanostructures.

### EXAMPLE 4

### SERS Measurement

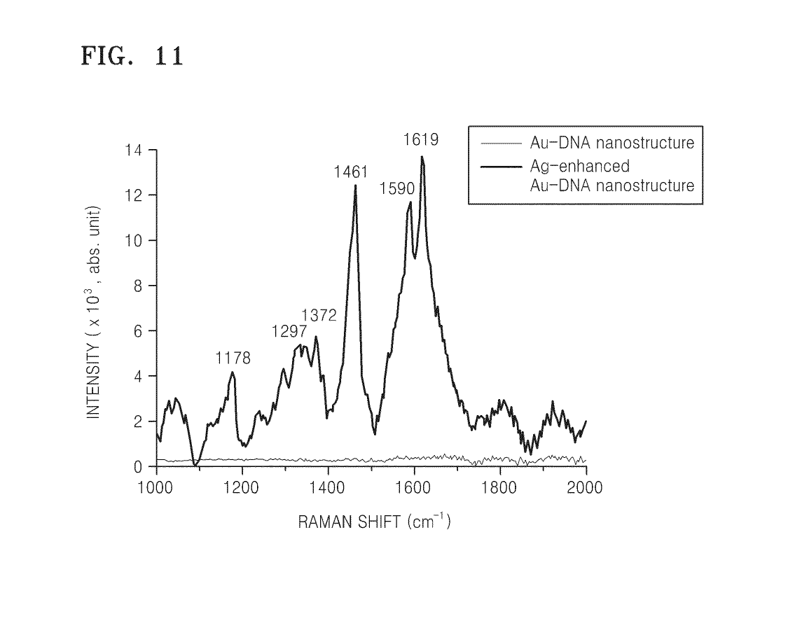

After dropping 0.5 μl of a sample droplet onto a silicon specimen, a 514.5 nm excitation laser at laser power 100%, and 1 sec of accumulation time, was applied, and surface enhanced Raman scattering signals magnified at 20× were measured using an in Via model apparatus (Renishaw Co., Ltd.). FIG. 11 shows a result of an SERS spectrum measured using an Au-DNA nanostructure and an Ag_{E}/Au-DNA nanostructure according to an exemplary embodiment of the present invention. As shown in FIG. 11, it was confirmed that there was no signal amplification in Au-DNA nanostructures, but in the case of Ag_{E}/Au-DNA nanostructures where Ag was coated on the surface of Au particles, SERS measurement was enabled by signal amplification.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An interparticle spacing material comprising:
a nucleic acid structure comprising a planar nucleic acid lattice with a double helix domain; and
at least one metal particle attached to the nucleic acid lattice and extending in a direction oblique or perpendicular to the plane of the nucleic acid lattice;
wherein the double helix domain comprises a hybridization area in which a single strand is hybridized with another single strand.

2. The interparticle spacing material according to claim 1, wherein at least two nucleic acid lattices form a multi-crossover nucleic acid structure including at least two crossover points each formed by at least two neighboring nucleic acid lattices via a branched junction.

3. The interparticle spacing material according to claim 2, wherein the at least two nucleic acid lattices are located on the same plane.

4. The interparticle spacing material according to claim 2, wherein the at least two nucleic acid lattices are DAE, DAO, DPE, DPON, or DPOW.

5. The interparticle spacing material according to claim 2, wherein the multi-crossover nucleic acid structure is a double-crossover nucleic acid, a triple-crossover nucleic acid, or combinations thereof.

6. The interparticle spacing material according to claim 1, wherein the plane of the nucleic acid lattice is parallel with the axis of a double helix of the double helix domain.

7. The interparticle spacing material according to claim 1, wherein the interparticle spacing material has two metal particles.

8. The interparticle spacing material according to claim 7, wherein the metal particles comprise the same material.

9. The interparticle spacing material according to claim 7, wherein the metal particles are substantially equal in diameter.

10. The interparticle spacing material according to claim 1, wherein the nucleic acid structure is self-assembled, and has a shape predetermined by the programmed base pairing of the nucleic acid structure.

11. The interparticle spacing material according to claim 1, wherein the nucleic acid structure comprises DNA.

12. The interparticle spacing material according to claim 1, wherein the nucleic acid structure further comprises a linker compound which connects the at least one metal particle to the nucleic acid lattice.

13. The interparticle spacing material according to claim 1, wherein the at least one metal particle is selected from the group consisting of Au, Ag, Cu, Na, Al, Cr, Pt, Ru, Pd, Fe, Co, Ni and combinations thereof.

14. The interparticle spacing material according to claim 1, wherein the at least one metal particle is a core-shell metal particle consisting of different metals.

15. The interparticle spacing material according to claim 14, wherein the core-shell metal particle comprises a core and a shell, and the core is formed of Au and the shell is formed of Ag.

16. The interparticle spacing material according to claim 1, wherein the nucleic acid structure includes a Raman scattering active molecule.

17. The interparticle spacing material according to claim 16, wherein the Raman scattering active molecule is selected from the group consisting of cyanine, fluorescein, rhodamine, 7-nitrobenz-2-oxa-1,3-diazole (NBD), phthalic acid, terephthalic acid, isophthalic acid, cresyl fast violet, cresyl blue violet, brilliant cresyl blue, p-aminobenzoic acid, erythrosine, biotin, digoxigenin, phthalocyanine, azomethine, xanthine, N,N-diethyl-4-(5′-azobenzotriazolyl)-phenylamine, aminoacridine, and combinations thereof.

18. A method of controlling interparticle spacing comprising:
connecting at least one metal particle to each opposing lateral side of a nucleic acid structure in a direction extending obliquely or perpendicularly away from a plane of the nucleic acid structure, wherein the nucleic acid structure comprises a double helix domain comprising a hybridization area in which a single strand is hybridized with another single strand.

19. A method of detecting a target material by using an interparticle spacing material, the method comprising:
providing an oligonucleotide comprising at least one pair of complementary nucleotide sequences;
forming a nucleic acid structure by hybridizing the pair of complementary nucleotide sequences of the oligonucleotide;
connecting at least one metal particle with each opposing lateral side of the nucleic acid structure in a direction extending obliquely or perpendicularly away from the plane of the nucleic acid structure;
exposing the interparticle spacing material to a sample including a target material; and
detecting plasmon formed from the target material and the interparticle spacing material.

20. An interparticle spacing material comprising:
a nucleic acid structure comprising a nucleic acid lattice with a double helix domain; and
at least one metal particle attached to the nucleic acid lattice and extending in a direction oblique or perpendicular to the axis of a double helix of the double helix domain;
wherein the double helix domain comprises a hybridization area in which a single strand is hybridized with another single strand.
